(19) United States
(12) Patent Application Publication
(10) Pub. No.: US 2009/0084023 A1
(43) Pub. Date: Apr. 2, 2009

(54) Air screen flying insects repellent system

(76) Inventor: Jay Fredrick Seniff, New Carlisle, IN (US)

Correspondence Address: R. TRACY CRUMP, P.O. BOX 604, 32790 DUNN ROAD, NEW CARLISLE, IN, 46552, US

(21) Appl. No.: 11/906,276

(22) Filed: Oct. 1, 2007

(51) Int. Cl. A01M 1/20

(52) U.S. Cl. 43/131

(57) ABSTRACT

The air screen flying insect repellant system includes a series of perimeter blowers designed and arranged to circulate a vertical air curtain from one blower to the next to create a physical barrier of continuous moving air around the “insect free” zone. The velocity of the moving air curtain is maintained between the blowers by the action of the tangential fans, which draw air into the blower from the adjacent blower, as well as propelling air outward toward the next adjacent blower. The blowers maintain the velocity of the air curtain at sufficient velocities (generally over 3.6 miles per hour) to prevent mosquitoes from passing between the blowers. The blowers also incorporate a mechanism for dispersing insect repellent or fragrance into the air curtain. The dispersion mechanism allows insect repellants to be actively or passively introduced into the air curtain to further deter the encroachment of mosquitoes and other flying insects. The air screen repellant system can be adapted to provide an “insect free” zone for any outdoor or “open air” application.

This invention relates to flying insect repellant systems, and in particular an air screen repellant system.

### BACKGROUND OF THE INVENTION

Outdoor enjoyment is often diminished by the encroachment of mosquitoes and other flying insect. Studies have shown that mosquitoes avoid places with wind speeds that approach their own flying speeds, which depending on species range generally between 0.9 and 1.5 mph (miles per hour). Wind speeds above this level interfere with the mosquitoes ability to fly. It is also known that mosquitoes are attracted to the plume of carbon dioxide and lactic acid that humans release during respiration and perspiration. Since wind helps disperse the plume of carbon dioxide and lactic acid given off by humans, wind can also be used to hide humans from the mosquitoes.

Various devices and methods have been used to reduce the presence of mosquitoes and other flying insects in various outdoor and open air settings. Some rely on the attraction of insects to devices that kill or trap the insects. The most common method is chemical insecticides and repellants. Insecticides simply kill the insects within the area. Chemical repellants are dispersed in the air or applied to the ground within the desired area to be rid of insects. Other chemical repellants are applied directly to the exposed skin to prevent the insects from being attracted directly to humans.

Various fans and air screen devices have also been developed as a mosquito and flying insect deterrent. These fans and air screen devices generate an air flow, which is designed to create a physical barrier of moving air through which the mosquitoes will not pass. These fans and air screen devices have had limited success because they often only generate the air barrier across a planar opening and cannot create a perimeter barrier around any particular area.

### SUMMARY OF THE INVENTION

The present invention seeks to provide an air screen repellant system that can be adapted to provide an “insect free” zone for any outdoor or “open air” application. The various embodiments of the air screen repellant system of this invention use a series of blowers designed and arranged to circulate a continuous vertical air curtain from one blower to the next to create a physical barrier of continuous moving air around the perimeter of an “insect free” zone. The blowers can be configured and arranged to accommodate an outdoor area of any shape or size and can be integrated directly into the construction of a deck, patio, shelter or other open air structure. The velocity of the moving air curtain is maintained between the blowers by the action of tangential fans, which draws air into the blower from the adjacent blower, as well as propelling air outward toward the next adjacent blower. The blowers maintain the velocity of the air curtain at sufficient velocities (generally over 2.0 mph (miles per hour) to prevent mosquitoes from passing between the blowers. The movement of the air curtain also helps disperse the carbon dioxide and lactic acid plume emitted by humans that attracts mosquitoes and prevents the mosquitoes from locating its source. Other embodiments of this invention can also incorporate into the blowers a mechanism for dispersing insect repellent or fragrance into the air curtain. The dispersion mechanism allows insect repellants, such as DEET, to be actively or passively introduced into the air curtain to further deter the encroachment of mosquitoes and other flying insects.

These and other advantages of the present invention will become apparent from the following description of an embodiment of the invention with reference to the accompanying drawings.

### BRIEF DESCRIPTION OF THE DRAWINGS

The drawings illustrate an embodiment of the present invention, in which:

FIG. 1 is a perspective view of an embodiment of the present invention incorporated into a patio deck;

FIG. 2 is a top view of the embodiment of FIG. 1;

FIG. 3 is a side view of side blowers from the embodiment of FIG. 1;

FIG. 4 is a front view of the side blower of FIG. 3;

FIG. 5 is a top section view of the side blower of FIG. 3;

FIG. 6 is a perspective view of another embodiment of the side blowers having a portion cutaway to reveal a repellant dispersion mechanism;

FIG. 7 is a top section view of the side blower of FIG. 6;

FIG. 8 is a perspective view of another embodiment of the side blowers having a portion cutaway to reveal a second repellant dispersion mechanism; and

FIG. 9 is a top section view of the side blower of FIG. 8.

### DESCRIPTION OF THE PREFERRED EMBODIMENT

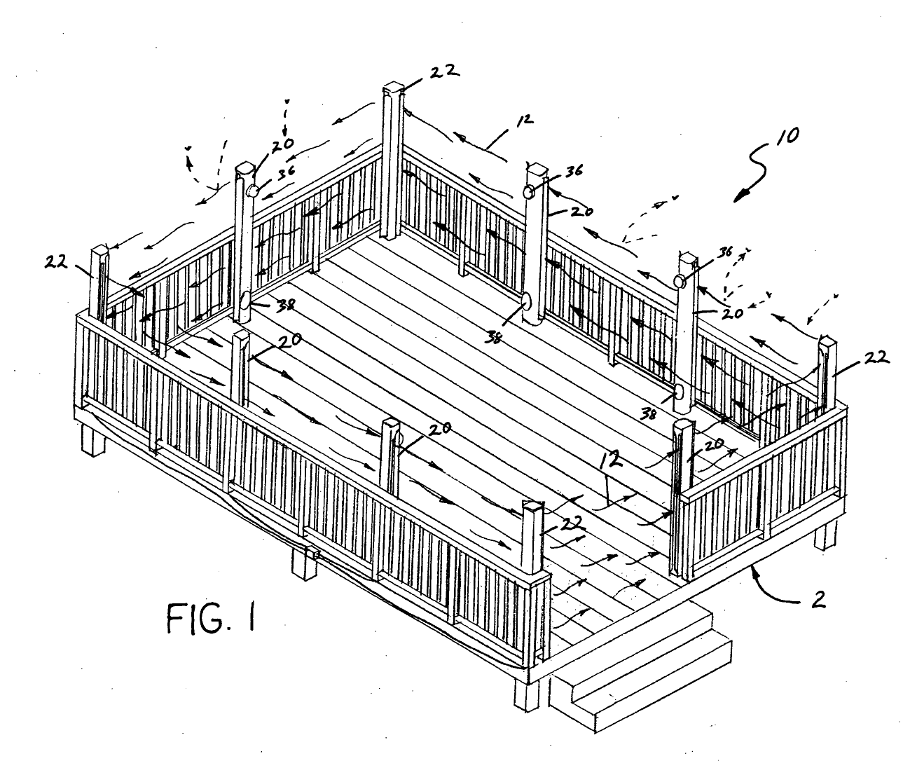

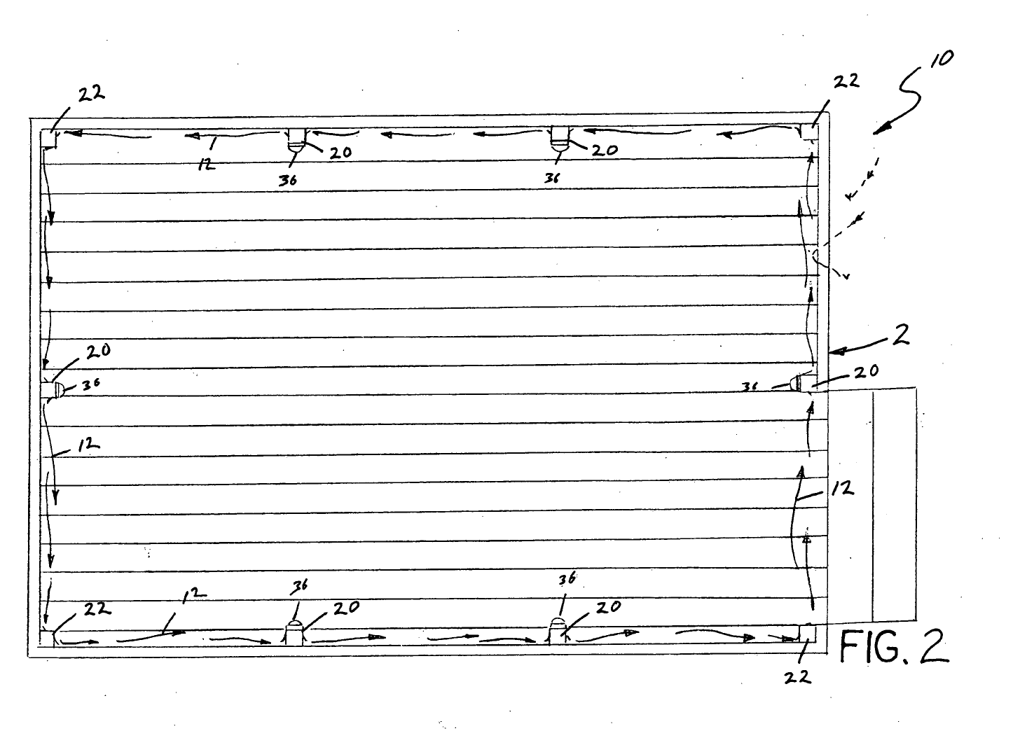

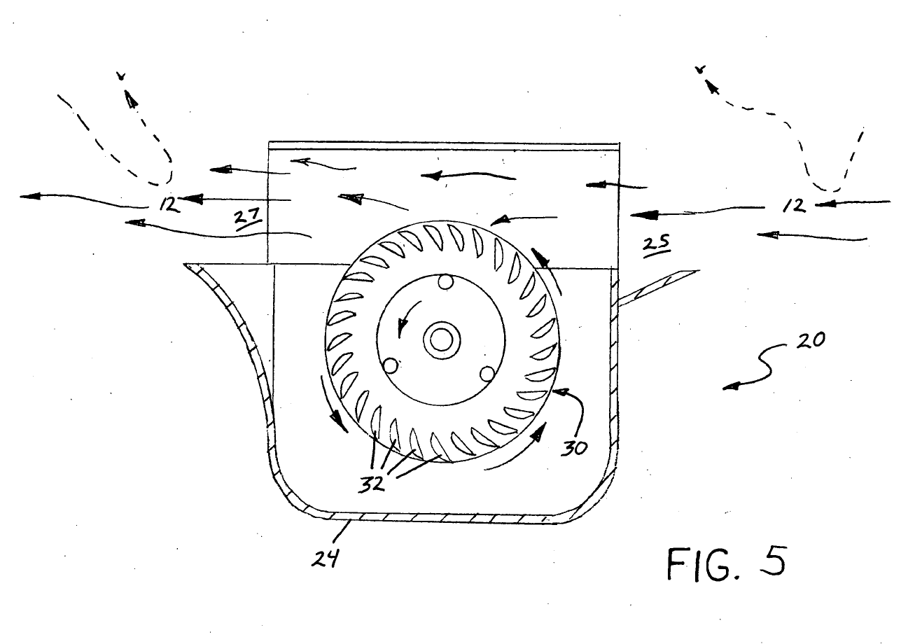

Referring now to the drawings, FIGS. 1-5 shows an embodiment of the present invention where reference numeral 10 generally designates an mosquito air screen repellant system used with a simple patio deck 2. As shown, air screen repellant system 10 creates a curtain of continuously moving air 12 around the perimeter of a patio deck 2. Air screen repellant system 10 includes a plurality of upright side and corner blowers 20 and 22 spaced along the perimeter of patio deck 2.

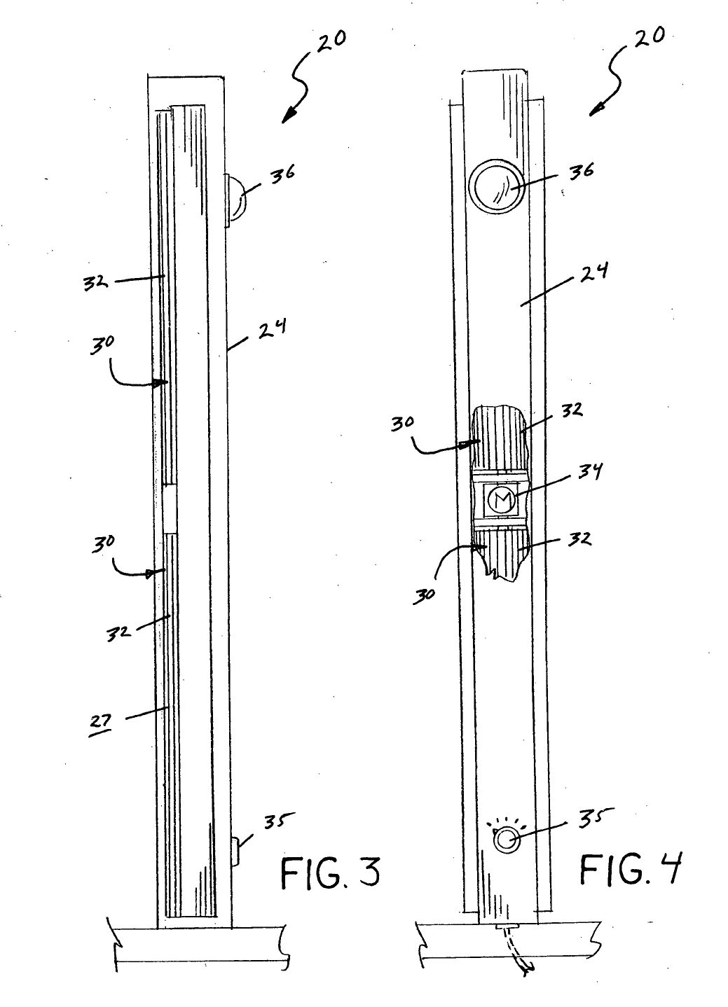

Each of blowers 20 and 22 stand approximately 6 feet tall and include a tangential fan 30 disposed within a slender blower housing 24. Ideally, blower housing 24 is stamped sheet metal, formed from a durable vinyl plastic or constructed from any suitable material. In addition, column housing 24 may be decorated or embellished to match or enhance the appearance and decor of the patio deck, porch or shelter as required. As best shown in FIGS. 3-5, column housing 24 has a generally rectangular cross section, but may be configured with any desirable shape or contour. Tangential fans 30 extend substantially the entire length of column housing 22. Each tangential fan 30 includes two cylindrical vanes 32 driven by an electric motor 34. Tangential fans 30 are selected to generate an air flow of approximately 400 cfm (cubic feet per minute), with an air flow velocity greater than 2.0 mph (miles per hour) over a distance of 8-10 feet. The fans are also selected to operate as quietly as possible. The motor of each blower is electrically wired to an electrical controller of rheostat 35 and AC power supply, which allows a user to activate the blowers. Each blower housing 24 has a vertical inlet opening 25 and a vertical outlet opening 27. One skilled in the art will note that inlet and outlet openings 25 and 27 are located on opposite sides of column housing 24 in corner blowers 20 and are located orthogonally (at 90 angles) on adjacent sides of column housing 24 in corner blowers 22.

As shown, the plurality of blowers 20 are spaced around the perimeter of patio deck 2 approximately every eight feet. Blowers 20 generate a continuous vertical air curtain 12, which is circulated from one blower to the next around the perimeter of patio deck 2. Fans 30 are selected to create an air curtain having at least an average velocity of 2.0 miles per hour. Blowers 20 and 23 are spaced around the perimeter so that the output air flow from one blower is drawn into the next blower, which creates a curtain of air flow moving at a relatively constant rate around the perimeter of patio deck 2. The rotation of fan vanes 32 creates a negative pressure that draws airflow into the blower through inlet opening 25 and a positive pressure that expels an airflow through outlet opening 27. Air curtain 12 creates a physical barrier, which prevents mosquitoes and other flying insects from entering the area of patio deck 2. Air curtain 12 generated by blowers 20 and 22 extends vertically approximately six feet (6′) above patio deck 2.

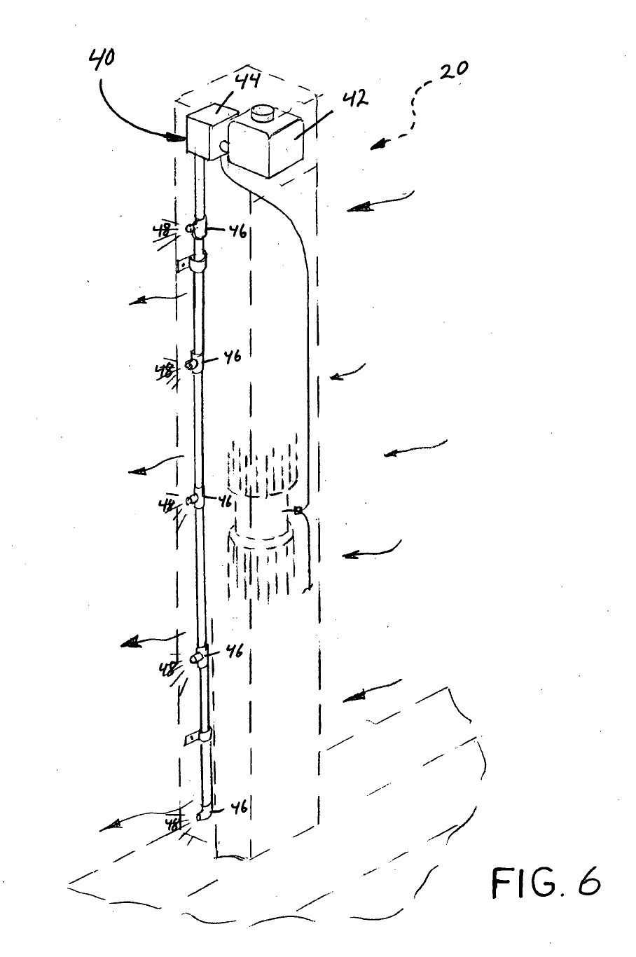

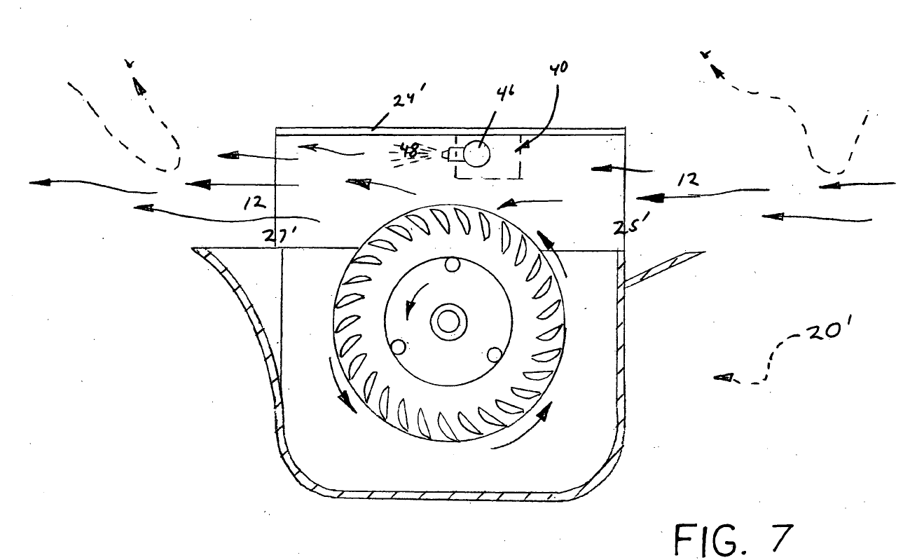

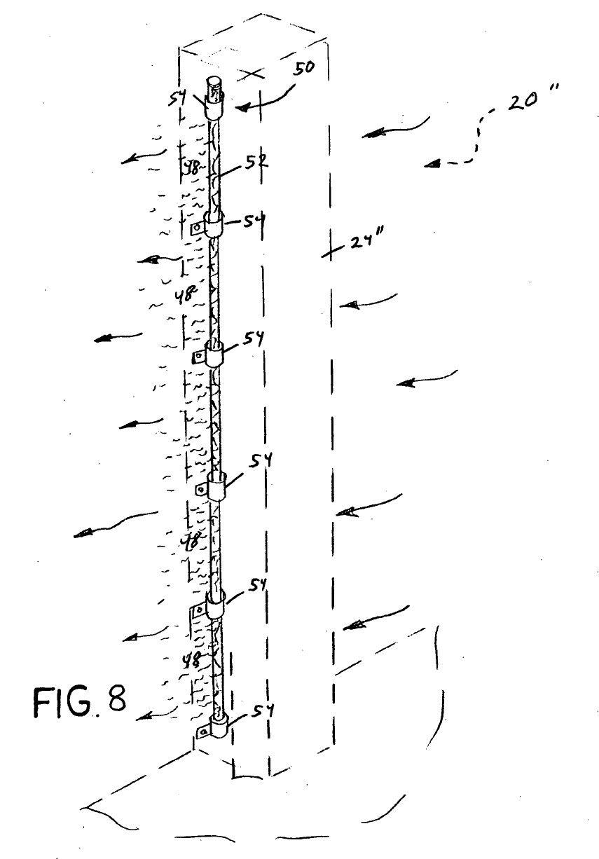

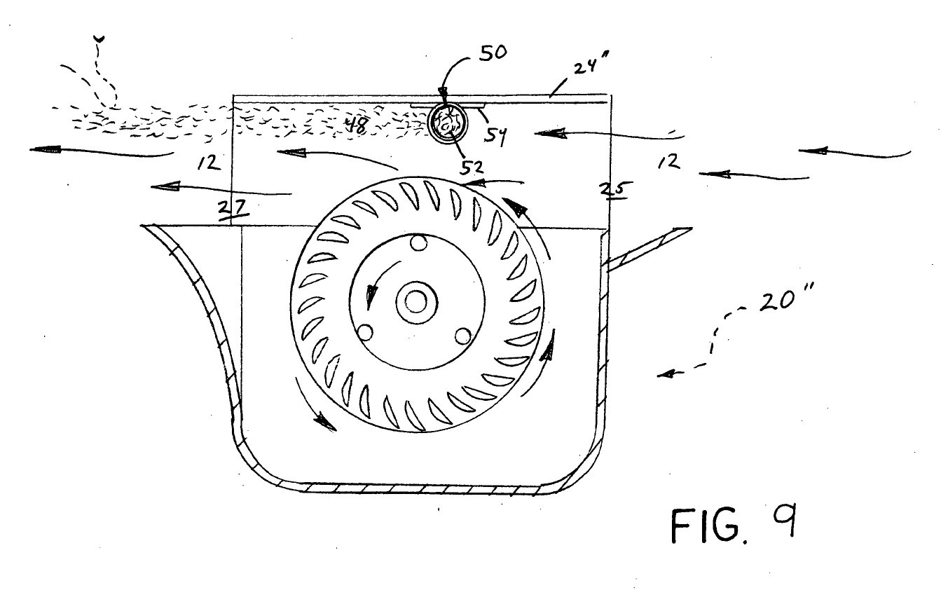

FIGS. 6-9 illustrate additional embodiments of the present invention where blowers 20 and 22 include a mechanism for dispersing insect repellent or fragrance into the air curtain. FIGS. 6 and 7 illustrate an active dispersion mechanism 40 incorporated into blower 20′. Dispersion mechanism 40 includes a small liquid reservoir 42 for an insect repellant, such as DEET (N,N-diethyl-3-methylbenzamide) or fragrance oil, an electric low pressure fluid pump 44 and a plurality of mist nozzles 46 operating with the pump and mounted to the inside of column housing 24. Reservoir 22 is accessible through an opening in the top of column housing 22′, which can be enclosed by a housing cap (not shown). Ideally, fluid pump 44 is operated by an electronic controller, which periodically releases the insect repellant or fragrance 48 into the airflow exiting outlet openings 27′ on a timer or manually by the activation of a switch (not shown). FIGS. 8 and 9 show an alternative passive dispersion mechanism 50 incorporated into blower 20″. Dispersion mechanism 50 includes a removable scent diffuser 52. Diffuser 52 is a wooden reed, fibrous rod or woven cloth cord, which is soaked or impregnated with DEET or fragrance oils. A plurality of collar clamps 54 hold diffuser 52 in place inside of housing 24″. Again, diffuser 52 is accessible through an opening in the top of column housing 24″. Soaking or impregnating diffuser 52 in insect repellant or fragrance oil 48 and placing it within the air passage of the column housing allows scent to be infused into the air curtain of the blower.

It should be noted that blowers 20 and 22 may be integrated as posts for the fences and railings around the decks, porches, patios and yards. Integrating the blowers into such fence and railing posts provides an insect repellant system that is unobtrusive and aesthetically pleasing. The blowers may be located and configured to form a desired insect-free boundary. In addition, blowers 20 and 22 can also be incorporated with additional conveniences, such as lighting 36 and sound speakers 38. As shown in FIG. A, lighting 36 can be mounted to blower housings 24 and wired into the electrical systems used to run the tangential fans. Similarly, sound speakers 38 are mounted within blower housings 24 and wired to conventional home A/V systems to provide music and ambient sound for the patio deck 2.

One skilled in the art will note that the present invention can be adapted to provide an “insect free” zone for any outdoor or “open air” application. The various embodiments of the air screen repellant system of this invention use a series of perimeter blowers designed and arranged to circulate a continuous vertical air curtain from one blower to the next, and thereby create a physical barrier of continuous moving air around the perimeter of an “insect free” zone. The velocity of the moving air curtain is maintained between the blowers by the action of the tangential fans, which draws air into the blower from the adjacent blower, as well as propelling air outward toward the next adjacent blower. The velocity of the air curtain is sustained at sufficient velocities (over 2.0 mph) to prevent mosquitoes from passing between the spaced blowers. The movement of the air curtain also helps disperse the carbon dioxide and lactic acid plume emitted by humans that attracts mosquitoes and prevents the mosquitoes from locating its source. Other embodiments of this invention incorporate into the blowers a mechanism for dispersing insect repellent or fragrance into the air curtain. The dispersion mechanism allows insect repellants to be actively or passively introduced into the air curtain to further deter the encroachment of mosquitoes and other flying insects. The combination of the series of perimeter blowers and the repellant dispersion mechanism fitted within the blowers provides an effective mosquito repellant system, which can be used in any outdoor or open air application.

The blowers can be configured and arranged to accommodate an outdoor area of any shape or size and can be integrated directly into the construction of a deck, patio, shelter or other open air structure. The blowers can be adapted to be powered electrically by available AC line current or DC batteries. The tall slender blowers provide an unobtrusive appearance. The blower housing can also be configured, painted and decorated to blend into the surrounding decor. The electric tangential fans operate quietly while still generating the air flow necessary to create the air curtain and all moving parts are enclosed in the blower housing for safety. The blowers can also be fitted with other conveniences, such as lighting and sound speakers.

The embodiment of the present invention herein described and illustrated is not intended to be exhaustive or to limit the invention to the precise form disclosed. It is presented to explain the invention so that others skilled in the art might utilize its teachings. The embodiment of the present invention may be modified within the scope of the following claims.

I claim:

1. A flying insect repellant system for creating an “insect free” area comprising:
a plurality of upright blowers spaced apart for creating a continuous vertical air curtain moving in series from one of the plurality of blowers to another of the plurality of blowers around the perimeter of the “insect free” area,
each of the plurality of blowers including a tangential fan that draws a first airflow from a first adjacent blower and expels a second airflow toward a second adjacent blower to form the vertical air curtain.

2. The repellant system of claim 1 wherein each of the plurality of blowers includes an upright housing having a vertical inlet opening and a vertical outlet opening defined therein and a tangential fan disposed within the upright housing.

3. The repellant system of claim 2 wherein the first airflow enters each of the plurality of blowers through the inlet opening and the second airflow exits each of the plurality of blowers through the outlet opening.

4. The repellant system of claim 1 wherein each of the plurality of blowers includes a mechanism for dispersing insect repellant into the air curtain.

5. The repellant system of claim 4 wherein the dispersing mechanism includes a reservoir mounted to the blower for receiving the insect repellant, and pump means mounted to the blower and operatively connected to the reservoir for dispersing the insect repellant into the second airflow.

6. The repellant system of claim 5 wherein each of the plurality of blowers includes an upright housing defining an interior having an open top and a cap covering the open top, the reservoir mounting within the housing interior and accessible through the open top.

7. The repellant system of claim 4 wherein the dispersing mechanism includes a diffuser disposed within the blower and impregnated with the insect repellant whereby the insect repellant is dispersed into the second airflow.

8. The repellant system of claim 1 wherein each of the plurality of blowers includes a light.

9. The repellant system of claim 1 wherein each of the plurality of blowers includes a sound speaker.

10. A flying insect repellant system for creating an “insect free” area comprising:
a plurality of upright blowers spaced apart for creating a continuous vertical air curtain moving in series from one of the plurality of blowers to another of the plurality of blowers around the perimeter of the “insect free” area,
each of the plurality of blowers including a tangential fan that draws a first airflow from a first adjacent blower and expels a second airflow toward a second adjacent blower to form the vertical air curtain, each of the plurality of blowers includes an upright housing having a vertical inlet opening and a vertical outlet opening defined therein and a tangential fan disposed within the upright housing such that the first airflow enters each of the plurality of blowers through the inlet opening and the second airflow exits each of the plurality of blowers through the outlet opening.
